(19) United States
(12) Patent Application Publication
(10) Pub. No.: US 2008/0078131 A1
(43) Pub. Date: Apr. 3, 2008

(54) Custom fabric storm cover for openings in structures

(75) Inventor: Darius H. Grimes, Cantonment, FL (US)

Correspondence Address: Andrew B. Morton;RENNER, KENNER, GREIVE,, BOBAK, TAYLOR & WEBER, First National Tower, Fourth Floor, Akron, OH, 44308-1456, US

(73) Assignee: Wayne-Dalton Corp.

(21) Appl. No.: 11/542,001

(22) Filed: Oct. 2, 2006

(51) Int. Cl. E06B 3/26

(52) U.S. Cl. 52/202

(57) ABSTRACT

A storm cover (10) to protect an opening in a structure includes a plurality of fabric panels (13) attached to each other by connectors (20). A receiver (24) is adapted to be attached to the structure and carries one end of the cover (10). A latch mechanism (30) includes a base (31) which is adapted to be attached to the structure. The latch mechanism (30) includes a tension connector (35) which is attached to the other end of the cover (10), and a tensioning arm (42) pivotally connected to the tension connector (35). Rotation of a handle (44) on the arm (42) positions a tab (39) of the tension connector (35) in a slot (33) in the base (31) and positions a pivot surface (46) of the arm (42) in a hook (34) in the base (31) to attach the other end of the cover (10) to the structure while at the same time tensioning the fabric.

### TECHNICAL FIELD

This invention relates to a fabric storm protection cover for an opening in a structure. More particularly, this invention relates to such a cover which can be custom constructed for large or unusually-sized openings. More specifically, this invention relates to such a cover which is constructed of a preselected plurality of panels attached together.

### BACKGROUND ART

Extreme weather-created phenomenon, such as hurricanes, typhoons, tornadoes, or the like can often cause damage to building structures. Such storm-related damage frequently occurs when high winds, and/or debris carried thereby, invade the structure through its weakest points, typically its window or door openings. Once invaded, the structure is vulnerable to further damage to the interior thereof, and thus, particularly in geographic areas susceptible to frequent violent weather conditions, it is important to protect the weakest portions of a structure, at least the windows and the doors, with some type of covering.

Most traditionally, home or building owners, if alerted to an oncoming storm, cover these portions of their structures by nailing plywood or other boards over them. However, this “boarding up” procedure is not only time consuming, when time is usually of the essence, but also such can disfigure the exterior of the structure upon the frequent installation and removal of the boards. In addition, the plywood or other boards are not only heavy and cumbersome to move, but also they will eventually deteriorate, and after frequent use, their fastening points are no longer effective. Moreover, storing or maintaining an inventory of the boards can take up a great deal of space which would otherwise be usable for other purposes.

As a result, a number of temporarily installable or permanently installed devices have been developed. However, in general, these devices are expensive, difficult to install or disassemble, and cumbersome to store. Furthermore, those which are not stored but rather which are permanent fixtures for the structure usually do not add aesthetic value to the structure but rather detract therefrom. For example, some of these devices are in the form of shutters which include rolled-up slatted material which must be rolled down, either manually or automatically by a motor, which increases the cost thereof. Alternatively, metallic panels, such as those made out of aluminum or steel, may be specially designed for each structure opening to be protected and mounted to the wall of the structure on a special frame. At times, a polycarbonate material such as LEXAN® has been substituted for the metallic portion of the device. However, all of these alternatives are rigid, heavy, cumbersome to store, quite expensive, not aesthetically pleasing, and, particularly in the case of the LEXAN® material, do not weather well.

More recently, fabric-based systems have been developed which are much less costly than the metallic shutters or other devices, and which can provide a cover for the openings in the structure. In their simplest form, these systems include a sheet of fabric which is strong enough to withstand high winds and the forces of wind borne debris without rupturing. These fabric sheets typically are provided with spaced openings along two opposed edges and fasteners are positioned in the structure at corresponding spaced locations so that they can be received through the openings in the fabric to attach the fabric to the structure.

One problem associated with the fabric storm covers just described is that they must be manufactured and inventoried in a variety of sizes dependent on the size of the openings to be protected, or the user must purchase sheets of the fabric and cut them to size himself. Such is particularly problematic where there are very large openings of varying sizes. Thus, the need exists for an easy manner of constructing covers to protect openings, particularly large openings, of varying sizes such as might be found in some homes, schools, factories, office buildings or the like.

### DISCLOSURE OF THE INVENTION

It is thus an object of the present invention to provide a fabric storm cover which can be readily assembled to accommodate windows of varying sizes.

It is another object of the present invention to provide a storm cover, as above, which is made up of a plurality of panels attached together, the number and size of the panels being dependent on the size of the opening to be protected.

These and other objects of the present invention, as well as the advantages thereof over existing prior art forms, which will become apparent from the description to follow, are accomplished by the improvements hereinafter described and claimed.

In general, a storm cover which is adapted to protect an opening in a structure and which is made in accordance with the present invention includes a plurality of fabric panels. Connectors attach adjacent panels together so that the cover has a first end and a second end. The first end is adapted to be removably attached to the structure, and the second end carries a latch mechanism which is adapted to connect the second end to the structure while at the same time tensioning the fabric panels over the opening.

The present invention also contemplates a method of covering an opening in a structure which includes the steps of connecting a plurality of fabric panels together to form a cover having first and second ends, attaching the first end of the cover to the structure at one side of the opening, and operating a latch mechanism to attach the second end of the cover to the structure at the other side of the opening while at the same time tensioning the fabric panels.

A preferred exemplary storm cover to protect an opening in a structure according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is fragmented perspective view of a storm cover made in accordance with the present invention showing it protecting a window opening in a structure.

FIG. 2 is an enlarged perspective view of a portion of the storm cover encircled in FIG. 1.

FIG. 3 is an enlarged perspective view of a portion of the storm cover encircled in FIG. 1.

FIG. 4 is an enlarged perspective view of a portion of the storm cover encircled in FIG. 1.

FIG. 5 is a fragmented, exploded, perspective view showing the manner in which individual fabric panels are connected to form the storm cover shown in FIG. 1.

FIG. 6 is a sectional view schematically showing the manner in which the end connectors of a panel are assembled.

FIGS. 7A-7C are sectional views schematically showing the manner in which the end connectors are attached to fabric material to form a panel.

FIGS. 8A and 8B are plan views schematically showing the manner in which a storm cover is tensioned over the opening in the structure

### PREFERRED EMBODIMENT FOR CARRYING OUT THE INVENTION

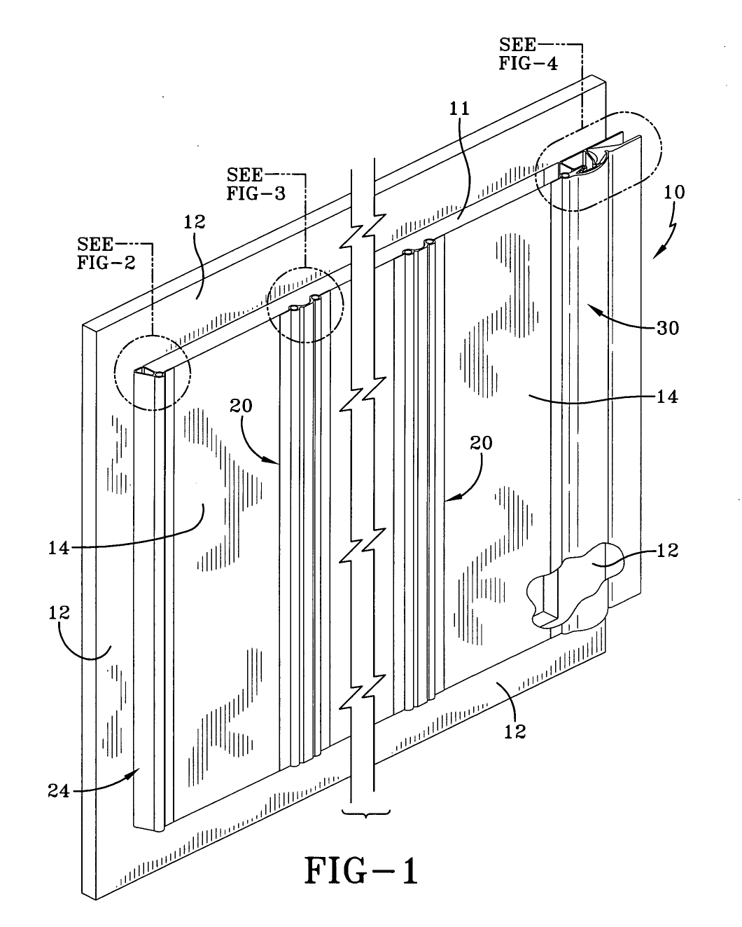

A storm cover made in accordance with the present invention is generally indicated by the numeral 10 and is designed to cover and protect an opening in a structure or building. Thus, storm cover 10 is shown in FIG. 1 as protecting a window 11 surrounded by the frame 12 of a building. While it is to be understood that storm cover 10 could also be used to protect doors and other openings in a structure, storm cover 10 is particularly suited to cover window openings which are large in length (or door openings of significant height) such as might be found, for example, in some homes, schools, office buildings or factories.

Storm cover 10 is made up of a plurality of panels generally indicated by the numeral 13. Each panel 13 includes a fabric sheet 14 which extends between end rod supports 15. Fabric sheet 14 may be of any suitable material capable of withstanding the forces generated by high winds or wind-borne debris. The fabric disclosed in U.S. patent application Ser. No. 11/190,114 filed Jul. 25, 2005, to which reference is made for whatever details are necessary to understand the present invention, is particularly suitable for fabric sheets 14. Rod supports 15 may be formed of any suitable sturdy material, such as aluminum or many forms of rigid plastic materials such as polyvinylchloride, polypropylene, acrylonitrile-butadiene-styrene, or the like.

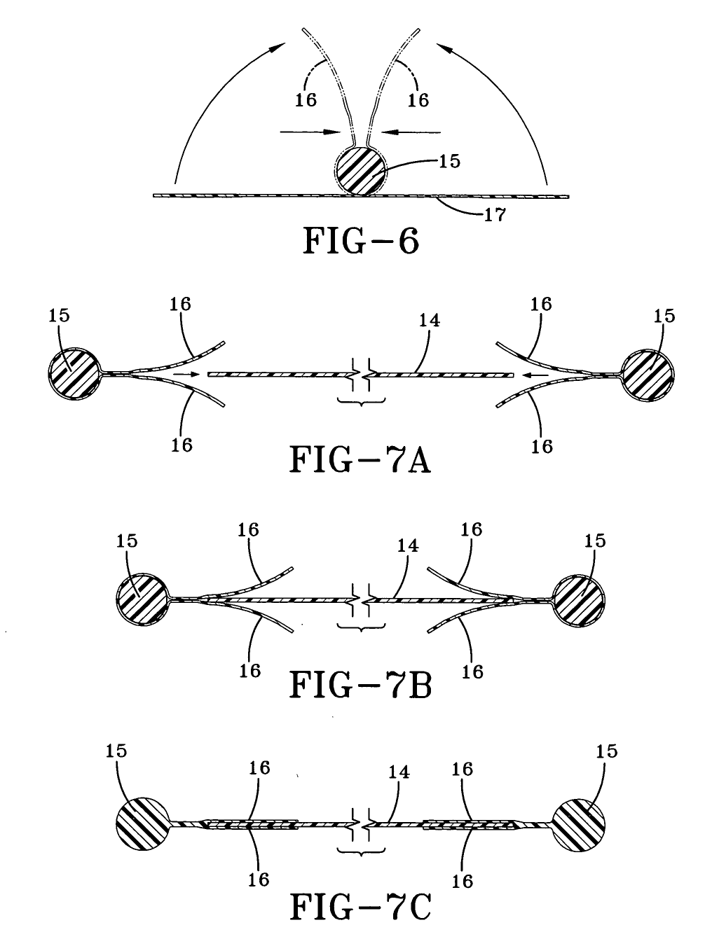

The manner in which each panel 13 is constructed is shown in FIGS. 6 and 7A-7C. Opposed flaps 16 extend from each rod support 15 and are formed by folding a piece of fabric 17, which can be the same type of fabric as sheets 14, around a rod support 15, and attaching the fabric 17 to a rod support 15 by any suitable means such as sewing, gluing, heat sealing or the like. The remaining material of fabric 17 that is not attached to rod support 15 forms opposed flaps 16. To attach rod supports 15 to a fabric sheet 14, flaps 16 are moved over the end of sheet 14 (FIG. 7A) until the ends of sheet 14 are fully seated within flaps 16 (FIG. 7B). Then flaps 16 may be attached to sheet 14 (FIG. 7C) by any suitable means such as sewing, gluing, heat sealing or the like, to form a panel 13.

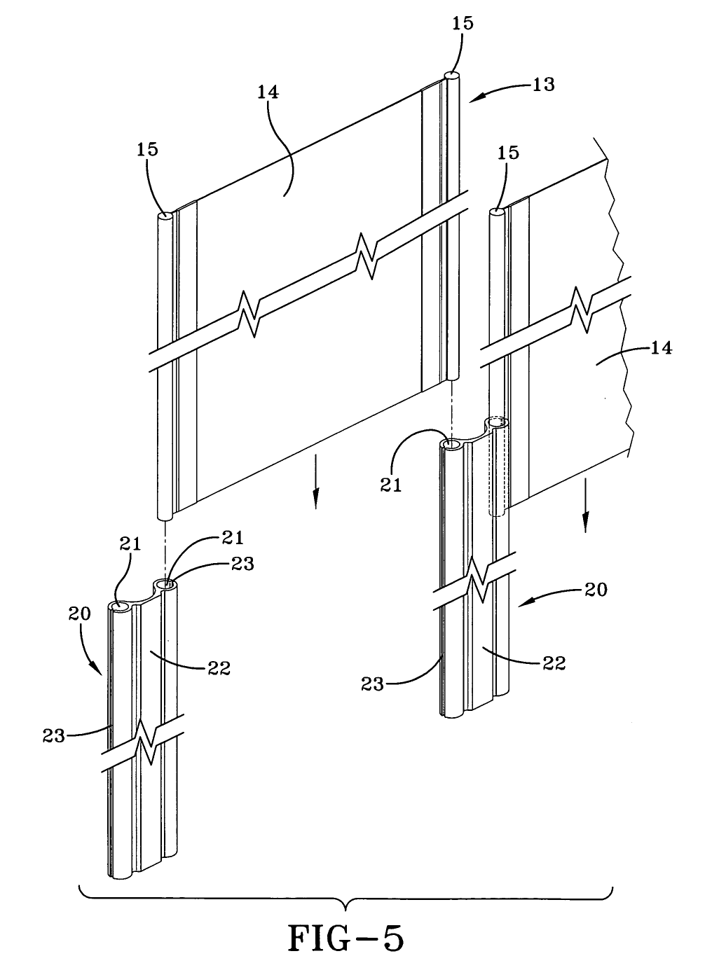

FIG. 5 best shows the manner in which panels 13 are connected to form storm cover 10. To that end, a binocular connector, generally indicated by the numeral 20, is provided between each panel 13. Connectors 20 may be made of aluminum or any suitable plastic material, such as polyvinylchloride, or the like, and include opposed vertical tubular apertures 21 carried at each end of a connecting strip 22. Apertures 21 each have a vertical slit opening 23 formed therein at a location generally opposed to strip 22. The rod support 15 of one panel 13 is received in one aperture 21 of a connector 20, and the rod support 15 of an adjacent panel 13 is received in the other aperture 21 of that connector 20, as by sliding the rods 15 in the apertures 21 as shown in FIG. 5. In so doing, the fabric sheet 14 of each panel 13 is received through slit openings 23. In such a manner, as many panels of as many sizes as necessary to cover the opening in the building may be attached together by using binocular connectors 20. In addition, connectors 20 add vertical stiffness to cover 10 to reduce deflection.

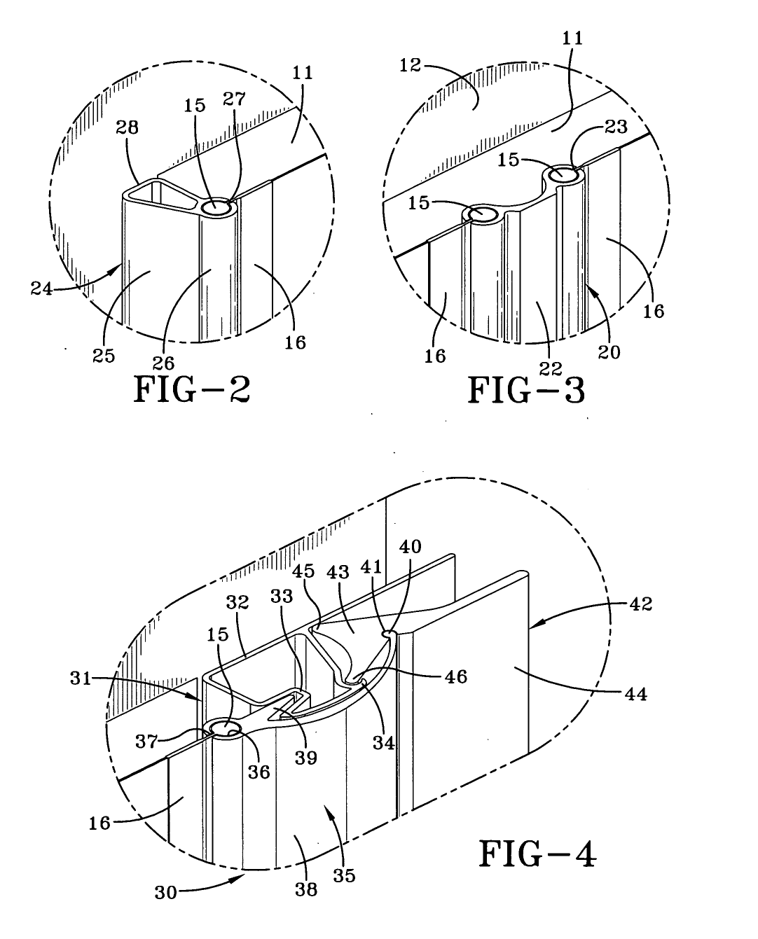

One end of storm cover 10 may be attached directly to the frame 12 of the structure. To that end, only one end of an end panel 13 receives a connector 20, and its rod support 15 at the other end is positioned in a receiver generally indicated by the numeral 24, which can be made of aluminum or a suitable plastic material, such as polyvinylchloride or the like. As best shown in FIG. 2, receiver 24 includes a generally triangular-shaped, hollow body portion 25 which carries a tubular aperture 26 which can be generally identical to tubular vertical apertures 21 of connectors 20. As such, aperture 26 is also provided with a slit opening 27 running the length thereof. The rod support 15 of the end panel 13 may thus be slid into aperture 24 with the fabric sheet 14 being received through slit opening 27. The body portion 25 can be attached to the building frame 12 most conveniently by utilizing fasteners (not shown) which can extend through the base 28 of body portion 25 and into the frame 12.

The other end of storm cover 10 can be attached to the opposed frame 12 via a latch mechanism generally indicated by the numeral 30 which also serves to tension cover 10. Latch mechanism 30 may be made of aluminum or any suitable plastic material such as polyvinylchloride or the like, and includes a vertically extending lock base, generally indicated by the numeral 31, which is fixed to frame 12 by conventional fasteners (not shown) received through the extension of rear surface 32 thereof. A slot 33 is formed on one side of lock base 31 near the end thereof opposed to rear surface 32, and a hook 34 is formed on the opposed side of base 31.

Latch mechanism 30 also includes a tension connector generally indicated by the numeral 35. A tubular aperture 36 is formed on one end of tension connector 35 which can be generally identical to tubular vertical apertures 21 of connectors 20. Thus, aperture 36 is provided with a slit opening 37 running the length thereof. An end panel 13, which is connected at one end to an adjacent panel 13 by a connector 20, has its rod support 15 at the other end slid into aperture 36 with the fabric sheet 14 being received through slot opening 37. Tension connector 35 is thus pivotally attached to the rod support 15 at the end of cover 10.

Tension connector 35 is somewhat J-shaped in top plan profile having a longer branch 38 with a tab 39 formed at one end thereof thereby creating the J-shape. A knuckle 40 is formed at the other end of branch 38 and is rotatably received (snap fit) in a recess 41 formed in a tension arm generally indicated by the numeral 42. Recess 41 of tension arm 42 is formed of a body portion 43 of arm 42, and a handle 44 extends outwardly from body 43. At the end of body 43 opposed to handle 44, a stop surface 45 and a pivot surface 46 are formed. Pivot surface 46 is received in hook 34 of lock base 31, and tab 39 is received in slot 33 of lock base 31.

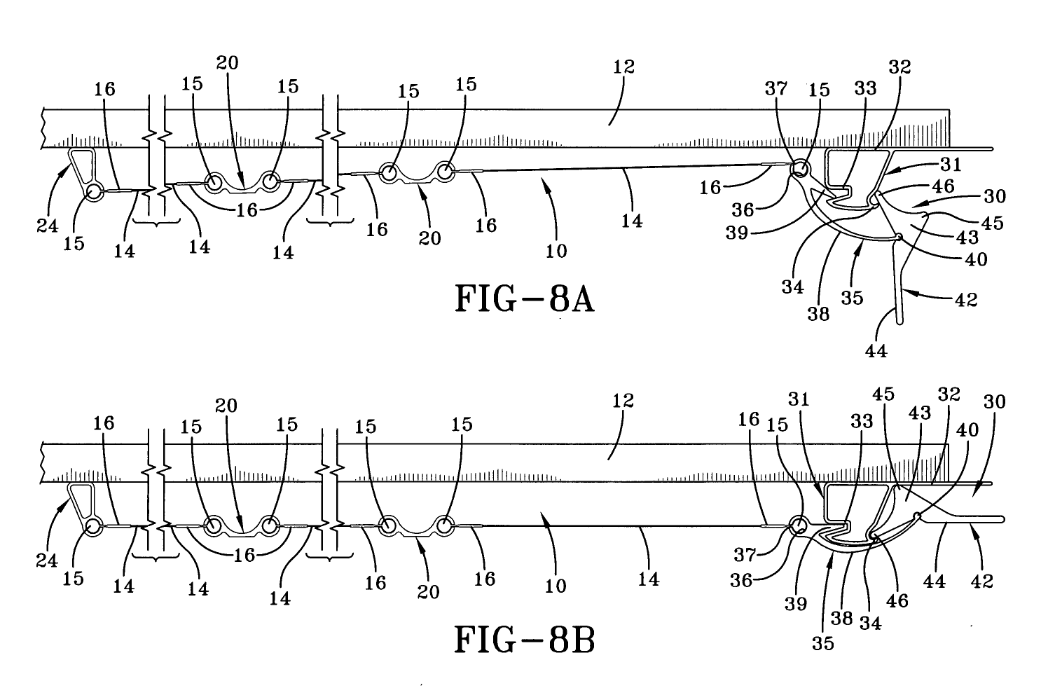

The manner in which latch mechanism 30 operates to lock and tension cover 10 in place is shown in FIGS. 8A and 8B. When it is desired to latch cover 10 in place, the components of latch mechanism 30 are first located as shown in FIG. 8A. That is, tab 39 is positioned at the entrance to slot 33, and pivot surface 46 is positioned adjacent to hook 34. Handle 44 is rotated counterclockwise, as viewed in FIG. 8A, until stop surface 45 engages the extension of rear surface 32 of lock base 31. At this point, as viewed in FIG. 8B, the camming action has tensioned the fabric 14 of cover 10, tab 39 is fully received in slot 33, and pivot surface 46 is fully seated in hook 34. Cover 10 is thus fully locked and tensioned in place to protect the window 11, and when the protection afforded thereby is no longer needed, latch mechanism 30 can be unlocked by rotating handle 44 in the opposite direction. Curtain 10 can then be removed from the structure, by removing it from receiver 24, and it can be rolled up and stored for future use, as needed.

It should thus be evident that a storm curtain constructed as described herein accomplishes the objects of the invention and otherwise substantially improves the art.

What is claimed is:

1. A storm cover adapted to protect an opening in a structure comprising a plurality of fabric panels; connectors to attach adjacent panels together so that the cover has a first end and a second end, said first end being adapted to be removably attached to the structure; and a latch mechanism carried by said second end, said latch mechanism adapted to connect said second end to the structure while at the same time tensioning said fabric panels over the opening.

2. The storm cover of claim 1 wherein each said fabric panel includes a sheet of fabric material having a first end and a second end, and a rod support carried by said first end and said second end of said fabric material.

3. The storm cover of claim 2 further comprising a piece of fabric material received around each said rod support and forming opposed flaps, said first and said second ends of said sheet of fabric material each being received between and attached to said flaps of a said piece of material so that said sheet of fabric material carries said rod supports.

4. The storm cover of claim 2 wherein each said connector includes spaced vertical apertures, one said apertures receiving a said rod support at one end of a said sheet of fabric material, and the other said aperture receiving a said rod support at one end of a said sheet of fabric material of an adjacent said fabric panel.

5. The storm cover of claim 4 wherein each said connector includes a strip of material connecting and spacing said vertical apertures.

6. The storm cover of claim 4 further comprising a slit in each said vertical aperture, a said sheet of fabric material being received through each said slit.

7. The storm cover of claim 1 further comprising a receiver adapted to be attached to the structure, said receiver carrying said first end of the cover.

8. The storm cover of claim 7 wherein each said fabric panel includes a sheet of fabric material and a rod support carried by at least one end of said sheet of fabric material, said one end being said first end of the cover.

9. The storm cover of claim 8 wherein said receiver includes a tubular aperture, said rod support being removably received in said tubular aperture.

10. The storm cover of claim 9 further comprising a slit in said tubular aperture, said sheet of fabric material being receivable through said slit.

11. The storm cover of claim 1 wherein said latch mechanism includes a base adapted to be attached to the structure, a tension connector attached to said second end and being operably receivable in said base, and an arm pivotally connected to said tension connector and being operably received in said base.

12. The storm cover of claim 11 wherein each said fabric panel includes a sheet of fabric material and a rod support carried by at least one end of said sheet of fabric material, said one end being said second end of the cover.

13. The storm cover of claim 12 wherein said tension connector includes a tubular aperture, said rod support being received in said tubular aperture.

14. The storm cover of claim 13 further comprising a slit in said tubular aperture, said sheet of fabric material being received through said slit.

15. The storm cover of claim 11 wherein said base includes a slot and said tension connector includes a tab receivable in said slot.

16. The storm cover of claim 15 wherein said base includes a hook and said arm includes a pivot surface receivable in said hook.

17. The storm cover of claim 16 wherein said arm includes a recess and said tension connector includes a knuckle pivotally received in said recess.

18. The storm cover of claim 17 wherein said arm includes a handle, the rotation of said handle relative to said base causing said tab to be received in said slot and said pivot surface to be received in said hook so that said fabric panel is connected to the structure and said fabric panels are tensioned.

19. The storm cover of claim 18 wherein said arm includes a stop surface, said handle being rotatable until said stop surface engages said base.

20. A method of covering an opening in a structure comprising the steps of connecting a plurality of fabric panels together to form a cover having a first end and a second end, attaching the first end of the cover to the structure at one side of the opening, and operating a latch mechanism to attach the second end of the cover to the structure at the other side of the opening while at the same time tensioning the fabric panels.
